(19) United States
(12) Patent Application Publication
(10) Pub. No.: US 2006/0265723 A1
(43) Pub. Date: Nov. 23, 2006

(54) Recording and/or reproducing apparatus

(75) Inventors: Eriko Ishihara, Kanagawa (JP); Satoru Takabayashi, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/416,128

(22) Filed: May 3, 2006

(30) Foreign Application Priority Data
May 18, 2005 (JP) 2005-145959

(51) Int. Cl. G11B 17/028

(52) U.S. Cl. 720/700

(57) ABSTRACT

Disclosed is a recording and/or reproducing apparatus, including: a chassis having an insertion/ejection port; a recording medium tray for holding a recording medium, which transfers it into a recording and/or reproduction position where recording and/or reproduction of data onto/from the recording medium are performed or transfers it to an ejected position outside the chassis; a panel in which the insertion/ejection port for the recording medium tray is formed and which is provided on one side surface of the main body of the apparatus; a lid body which can close the insertion/ejection port; and an elastic member provided between the lid body and recording medium tray. In a state where the insertion/ejection port is closed by the lid body, the elastic member pulls the lid body toward the inside of the chassis to allow the lid body to be brought into pressure contact with the panel by an elastic force of the elastic member to thereby reduce the size of a gap between the lid body and panel.

### CROSS REFERENCE TO RELATED APPLICATIONS

The present invention contains subject matter related to Japanese Patent Application JP 2005-145959 filed in Japanese Patent Office on May 18, 2005, the entire contents of which being incorporated herein by reference.

### BACKGROUND OF THE INVENTION

1. Field of the Invention

The present invention relates to a recording and/or reproducing apparatus having a recording medium tray for holding a recording medium which is inserted or ejected into/from a main body of the apparatus through an insertion/ejection port and a lid body for closing the insertion/ejection port provided in the recording medium tray.

2. Description of the Related Art

There is available a recording and/or reproducing apparatus for an optical disc such as CD (Compact Disc) or DVD (Digital Versatile Disc) having a disc tray for feeding an optical disc to a recording and/or reproducing section. In such a recording and/or reproducing apparatus, an insertion/ejection port is formed in a front panel of the main body of the apparatus, through which the disc tray is inserted or ejected into/from the apparatus main body. The insertion/ejection port is closed by a lid body attached to the front portion of the disc tray.

A gap of about 0.5 mm exists between the lid body and insertion/ejection port in a state where the insertion/ejection port of the front panel is closed by the lid body. This is because that the area of the lid body is set smaller than the area of the insertion/ejection port in order for an installation error of the disc tray or front panel not to impede a fit between the lid body of the disc tray and insertion/ejection port.

However, the gap formed between the insertion/ejection port and lid body attached to the disc tray appears as a visible groove, impeding further improvement of the appearance of the apparatus main body.

Further, dust or the like may be introduced into the inside of the insertion/ejection portion through the gap. An adherence of dust or the like to the signal recording surface of an optical disc onto which an information signal is recorded in a high density may impede the information signal from being recorded or read out correctly.

Patent Document 1: Jpn. Pat. Appln. Laid-Open Publication No. 10-312616

### SUMMARY OF THE INVENTION

The present invention has been made in view of the above problem, and it is desirable to provide a recording and/or reproducing apparatus capable of reducing the size of the gap, formed in the front surface of the apparatus main body, between the lid body attached to the disc tray and insertion/ejection port formed in the front panel of the apparatus main body as much as possible to improve the appearance of the apparatus.

Further, it is desirable to provide a recording and/or reproducing apparatus capable of reducing the size of the gap between the lid body attached to the disc tray and insertion/ejection port formed in the front panel of the apparatus main body to prevent introduction of dust or the like into the inside of the apparatus main body.

A recording and/or reproducing apparatus for recording/reproducing data onto/from a recording medium according to the present invention includes: a chassis having an insertion/ejection port; a recording medium tray for holding the recording medium, which transfers it into a recording and/or reproduction position where recording and/or reproduction of data onto/from the recording medium are performed or transfers it to an ejected position outside the chassis; a panel in which the insertion/ejection port for the recording medium tray is formed and which is provided on one side surface of the main body of the apparatus; a lid body which can close the insertion/ejection port; and an elastic member provided between the lid body and recording medium tray.

According to the present invention, the lid body which closes the insertion/ejection portion is movably coupled to the front surface portion of the recording medium tray by the elastic member. When the lid body closes the insertion/ejection port, the lid body is drawn toward the insertion/ejection port to thereby close the insertion/ejection port. Therefore, it is possible to reduce the size of a gap between the lid body and insertion/ejection port, thereby making it hard for dust or the like to be introduced into the inside and improving the appearance of the apparatus.

### BRIEF DESCRIPTION OF THE DRAWINGS

FIG. 1 is a perspective view showing the main part of a recording/reproducing apparatus according to the present invention;

FIG. 2 is a perspective view of a disc tray to which a lid body is attached through a base member, as viewed from the front surface side;

FIG. 3 is an exploded perspective view of the lid body, base member, and disc tray as viewed from the back surface side;

FIG. 4 is a perspective of a state where the base member is attached to the lid body as viewed from the back surface side;

FIG. 5 is a perspective view of an insertion/ejection port to which the lid body is substantially fitted;

FIG. 6 is a cross-sectional view showing a state where the lid body closes the insertion/ejection port;

FIG. 7 is a cross-sectional view showing a state where the insertion/ejection port is opened; and

FIG. 8 is a modification of the present invention and is a plan view showing a state where the disc tray and lid body are directly attached to each other; FIG. 8A shows a closed state; and FIG. 8B shows an open state.

### DETAILED DESCRIPTION OF THE PREFERRED EMBODIMENTS

A recording and/or reproducing apparatus according to the present invention will be described with reference to the accompanying drawings.

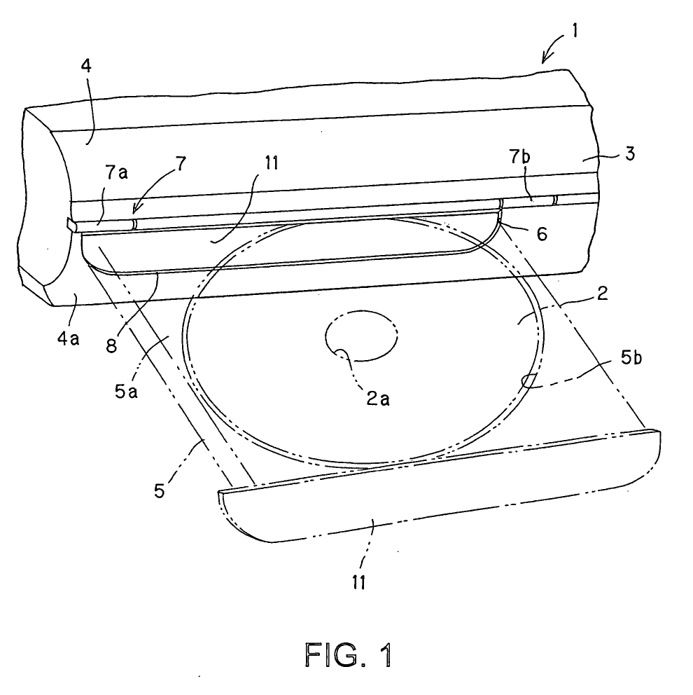

FIG. 1 is a perspective view showing the main part of a recording/reproducing apparatus 1 according to the present invention. The recording/reproducing apparatus 1 is a stationary type apparatus, which uses an optical disc 2 as a recording medium and has substantially a rectangular apparatus main body 3 serving as a chassis of the apparatus. A front panel 4 constituting an operation surface is attached to the front surface of the apparatus main body 3. An insertion/ejection port 6 of a disc tray 5 that holds the optical disc 2 is formed in the front panel 4.

An operation section 7 including operation buttons such as a power button 7a for the apparatus main body 3 and an eject button 7b for the disc tray 5 is formed on the front panel 4 at the area near the insertion/ejection port 6.

When the eject button 7b is depressed, the disc tray 5 of the apparatus main body 3 is moved into and out of the apparatus main body 3 through the insertion/ejection port 6 by a movement operation mechanism constituted by a motor, a plurality of gears, and the like incorporated in the apparatus main body 3. The disc tray 5 has a main body Sa having substantially a rectangular plate shape. A disc-shaped recessed portion 5b having substantially the same size as that of the optical disc 2 is formed on one surface of the tray main body 5a. The optical disc 2 is rotatably held in the disc-shaped recessed portion 5b. The disc tray 5 is drawn from the apparatus main body 3 to such a degree that the optical disc 2 in the disc-shaped recessed portion 5b can be removed or replaced with another disc, or housed into the apparatus main body 3 by a movement operation mechanism incorporated in the apparatus main body 3.

The apparatus main body 3 further includes a recording/reproducing section (not shown) that performs recoding and reproduction of data onto/from the optical disc 2 when the disc tray 5 is in the housing position. The recording/reproducing section has a rotation drive section that rotates the optical disc 2 placed on the disc-shaped recessed portion 5b when the disc tray 5 is in the housing position in the apparatus main body 3. The rotation drive section has a disc table engaged with a center hole 2a of the optical disc 2. The disc table is formed integrally with a drive shaft of a spindle motor. A clamping plate is attached to the position facing the disc table. The optical disc 2 is rotated integrally with the disc table in a state where being rotatably held between the disc table and clamping plate with the center hole 2a thereof engaged with the disc table.

The recording/reproducing section includes an optical pickup that is movable in the radial direction of the optical disc 2 attached to the disc table. The optical pickup has optical components such as a laser diode, an objective lens, a photodetector. A laser beam emitted from the laser diode is focused by the objective lens, and the focused beam is then irradiated on the signal recording surface of the optical disc 2. A returning laser beam reflected by the optical disc 2 is detected by the photodetector. Through the above operation, the optical pickup records and reads out an information signal onto/from the optical disc 2 while performing focusing control of the objective lens and tracking control. The optical pickup is configured to be moved in the radial direction of the optical disc 2 along with recoding/reproducing operation for the optical disc 2 by means of a sled mechanism constituted by a stepping motor, a plurality of gears, and the like.

A lid body 11 is attached to the front surface of the disc tray 5. The lid body 11 closes the insertion/ejection port 6 formed in the front panel 4 in a state where the disc tray 5 is housed in the apparatus main body 3. The shape of the lid body 11 corresponds to that of the insertion/ejection port 6, which is formed into a shape such that the upper and lower sides thereof are defined by straight lines and both corners of the lower side thereof are rounded. The lid body 11 is configured to be substantially fitted to the insertion/ejection port 6. Precisely, the lid body 11 is formed to have a size slightly smaller than that of the insertion/ejection port 6. Accordingly, a gap 8 is formed between the insertion/ejection port 6 and lid body 11 substantially fitted to the insertion/ejection port 6. The size of the gap 8 is smaller than before, preventing the appearance of the apparatus main body 3 from being degraded as well as preventing dust or the like from being introduced into the recording/reproducing section located inside the apparatus main body 3.

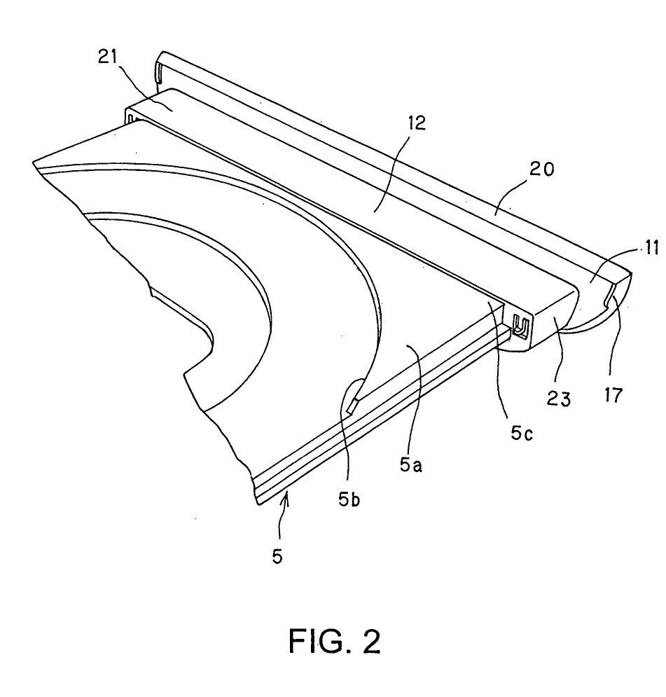

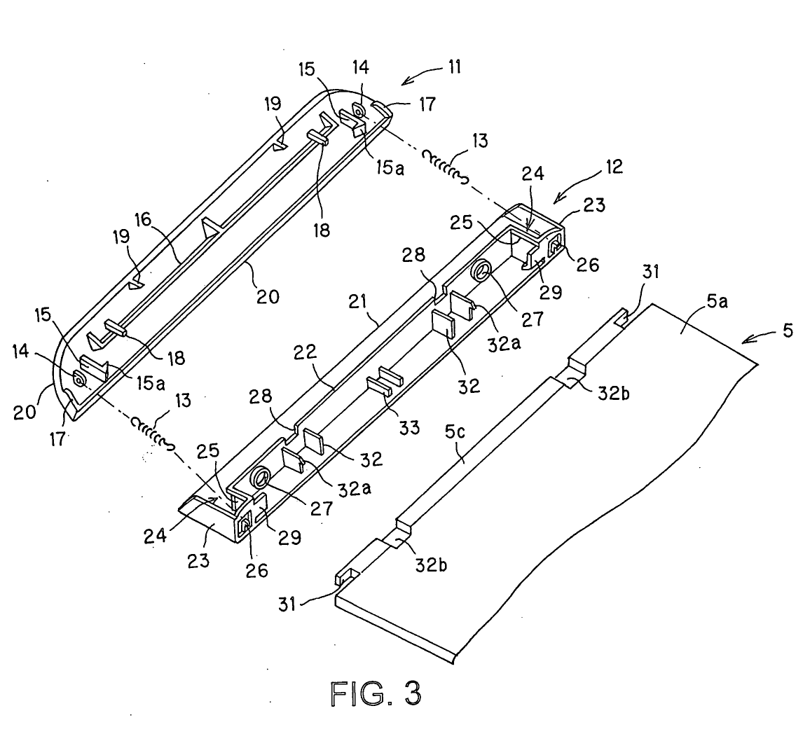

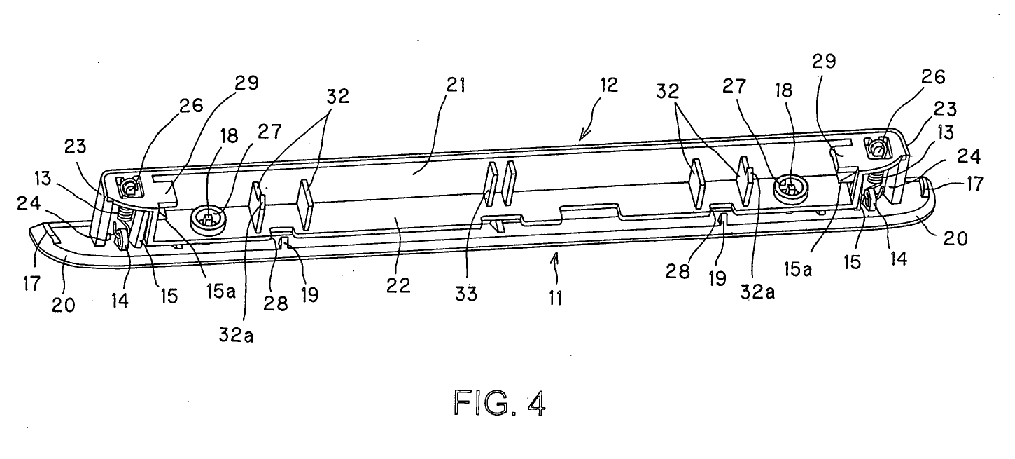

As shown in FIG. 2, the lid body 11 is attached to a front surface portion 5c of the disc tray 5 through a base member 12. The base member 12 is fixed to the front surface portion 5c of the disc tray 5 and is coupled to the lid body 11 through an elastic member 13 such as a coil spring or the like as shown in FIGS. 3 and 4. Lid-side fixation pieces 14, 14 are formed on both longitudinal sides of the back surface of the lid body 11, to which one end of the elastic member 13 is fixed. Guide pieces 15, 15 are formed between the lid-side fixation pieces 14, 14. The guide pieces 15, 15 extending in parallel with each other in the direction perpendicular to the longitudinal direction of the lid body 11. Engagement portions 15a, 15a are so formed on the distal ends of the guide pieces 15, 15 as to protrude to face each other. The engagement portions 15, 15 prevent the lid body 11 from being slipped out of the base member 12. A position restricting piece 16 extends in the longitudinal direction between the guide pieces 15, 15. The position restricting piece 16 restricts the position of the base member 12. Restricting pins 18, 18 are formed on the lower side of the position restricting piece 16. The restricting pins 18, 18 restrict displacement of the lid body 11 relative to the base member 12. Lid-side abutting portions 17, 17 are formed on both sides of the back surface of the lid body 11. The lid-side abutting portions 17, 17 abut against panel-side abutting portions formed on both sides of the insertion/ejection port 6 of the front panel 4. Stoppers 19, 19 are formed at the lower end of the back surface of the lid body 11. The stoppers 19, 19 prevent the lid body 11 from being displaced downward in a state where the lid body 11 has been fitted to the insertion/ejection port 6. A lid-side inclined surface 20 is formed on the outer peripheral surface of the lid body 11. The lid-side inclined surface 20 is inclined outwardly from the back surface side toward front surface side and serves as a guide surface to the insertion/ejection port 6 when the lid body 11 is fitted to the insertion/ejection port 6.

The base member 12 to which the lid body 11 having the above structure is attached is constituted by a cover plate 21 that covers the coupling portion between the lid body 11 and base member 12 from above and a reinforcing plate 22 rising from the cover plate 21, as shown in FIGS. 3 and 4.

The cover plate 21, which is formed into substantially a rectangular shape, has side plates 23, 23 on both short sides thereof. Insertion spaces 24, 24 into which the guide pieces 15, 15 of the lib body 11 are inserted are formed inside the side plates 23, 23. Engagement holes 25, 25 with which the engagement pieces 15a, 15a of the guide pieces 15, 15 are engaged are formed at the portions facing the side plates 23, 23. Each of the engagement holes 25, 25 is a through hole having substantially a rectangular shape with the direction that the lid body 11 comes close to or moves away from the base member 12 set as the long side direction. The lid body 11 comes close to or moves away from the base member 12 within a range that the engagement portions 15a, 15a of the guide pieces 15, 15 are moved in the engagement holes 25, 25.

Base-side fixation pieces 26, 26 are so formed as to face the lid body 11 on the cover plate 2l. One ends of the elastic members 13, 13 are fixed to the base-side fixation pieces 26, 26. Each of the elastic members 13, 13 is, e.g., a coil spring. One end of the coil spring is fixed to the lid-side fixation piece 14 and the other end thereof is fixed to the base-side fixation piece 26 to thereby couple the lid body 11 and base member 12 to each other. The guide pieces 15, 15 are inserted into the insertion spaces 24, 24. Further, the elastic members 13, 13 are provided in the insertion spaces 24, 24. The cover plate 21 closes the upper surface of the insertion spaces 24, 24 to thereby prevent the guide pieces 15, 15 and elastic members 13, 13 from being seen from the outside when the disc tray is ejected from the apparatus main body 3. Note that the elastic member 13 may be formed of a rubber.

The reinforcing plate 22 is formed perpendicular to the cover plate 21 having the above structure in an integrated manner with the cover plate 21 to thereby reinforce the strength of the cover plate 21. Restricting holes 27, 27 into which the restricting pins 18, 18 of the lid body 11 are inserted are formed on the reinforcing plate 22. The insertion of the restricting pins 18, 18 into the restricting holes 27, 27 restricts the displacement of the lid body 11 relative to the base member 12 in the left, right, up and down directions. Clearance recesses 28, 28 for the stoppers 19, 19 of the lid body 11 are formed in the leading end portion of the reinforcing plate 22.

Attachment pieces 29, 29 for attachment of the base member 12 to the disc tray 5 are formed adjacent to the base-side fixation pieces 26, 26 on the cover plate 21, as shown in FIGS. 3 and 4. The engagement between the attachment pieces 29, 29 and engagement recesses 31, 31 formed on both sides of the front surface of the disc tray 5 integrates the disc tray 5 and base member 12. Abutting pieces 32, 32, 33 are formed on the surface of the reinforcing plate 22 that faces the front surface of the disc tray 5. The abutting pieces 32, 32, 33 are configured to abut against the front surface of the disc tray 5. Fixation projections 32a, 32a are formed at the distal ends of the abutting pieces 32, 32. The fixation between the fixation projections 32a, 32a and recesses 32b, 32b formed on the front surface of the disc tray 5, as well as the engagement between the attachment pieces 29, 29 and engagement recesses 31, 31 prevents the base member 12 from being slipped out of the disc tray 5.

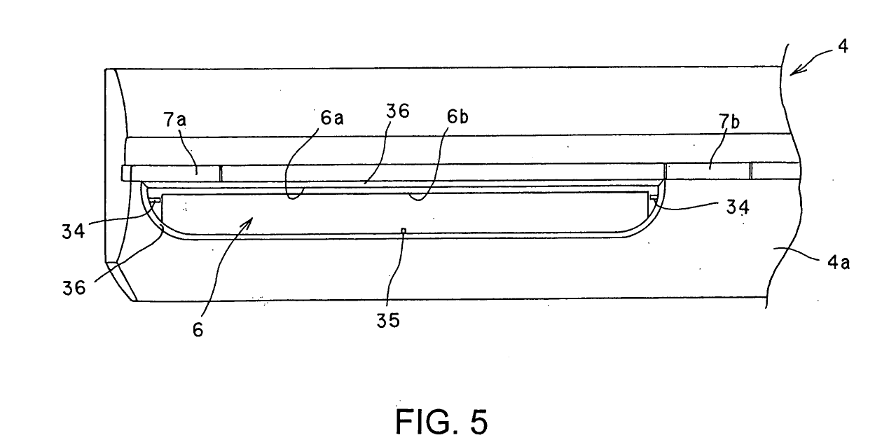

The insertion/ejection port 6 of the front panel 4 to which the lid body 11 attached to the disc tray 5 through the base member 12 is substantially fitted has, as shown in FIG. 5, a concave 6a which is concave relative to a panel surface 4a of the front panel 4. Formed on the bottom surface of the concave 6a is substantially a rectangular insertion hole 6b through which the disc tray 5 is inserted into or ejected from the apparatus main body 3. Panel-side abutting portions 34, 34 against which the lid-side abutting portions 17, 17 formed on the back surface of the lid body 11 abut are formed on both longitudinal sides of the insertion/ejection port 6, more concretely, on both sides of the insertion hole 6b. Further, a panel-side abutting portion 35 against which the lid body 11 abuts protrudes at substantially the center of the lower side of the insertion/ejection port 6.

A panel-side inclined surface 36 corresponding to the lid-side inclined surface 20 of the lid body 11 is formed on the side surface of the concave 6a of the insertion/ejection port 6. The panel-side inclined surface 36 serves as a guide surface to the insertion/ejection port 6 when the lid body 11 is fitted to the insertion/ejection port 6. The lid-side inclined surface 20 and panel-side inclined surface 36 are inclined at an angle of about 30 degree.

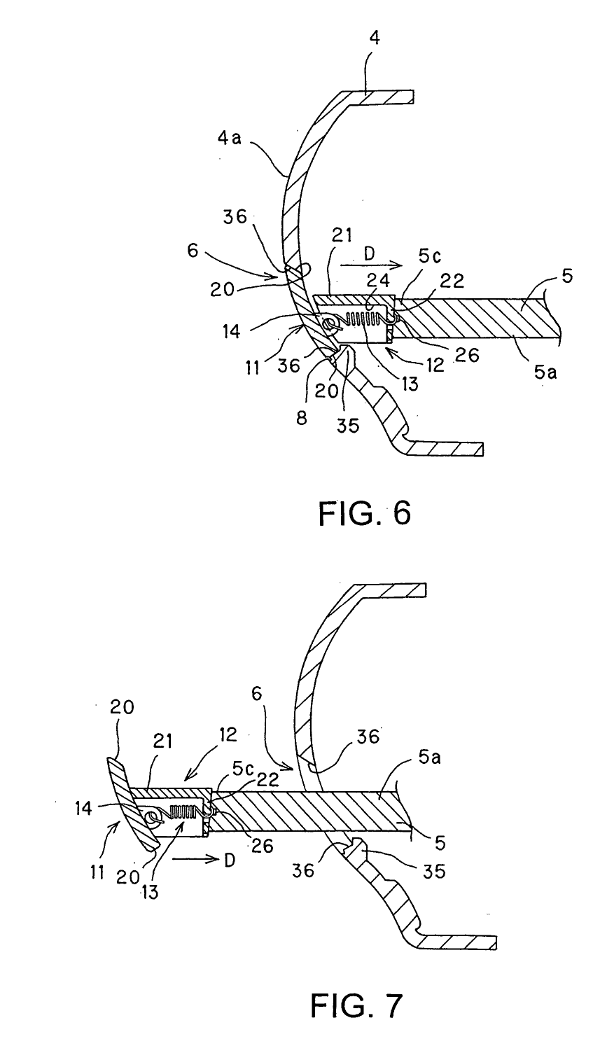

Next, an assembly method will be described. As shown in FIGS. 3 and 6, the lid body 11 is coupled to the base member 12 by the elastic member 13. More specifically, one end of the elastic member 13 is engaged with the lid-side fixation piece 14 of the lid body 11 and the other end thereof is fixed to the base-side fixation piece 26 of the base member 12. At the same time, the guide pieces 15, 15 of the lid body 11 are inserted into the insertion space 24 of the base member 12 to allow the engagement portions 15a, 15a to be engaged with the engagement holes 25, 25. Further, the restricting pins 18, 18 of the lid body 11 are inserted into the restricting holes 27, 27 of the base member 12. Further, the cover plate 21 of the base member 12 is overlapped on the position restricting piece 16 of the lid body 11. As a result, in a state where the lid body 11 has been attached to the base member 12, the upward movement of the lid body 11 is restricted due to the overlap of the cover plate 21 of the base member 12 on the position restricting piece 16, and the lid body 11 can move in the left, right, up and down directions relative to the base member 12 within a range of the restricting holes 27, 27 to which the restricting pins 18, 18 are inserted.

The base member 12 coupled to the lid body 11 by the elastic member 13 is attached to the front surface portion 5c of the disc tray 5. More specifically, the attachment pieces 29, 29 formed on the cover plate 21 are engaged with the engagement recesses 31, 31 formed on the front surface portion 5c of the disc tray 5, and the fixation projections 32a, 32a formed at the distal ends of the abutting pieces 32, 32 are fixed to the recesses 32b, 32b formed on the front surface of the disc tray 5. As a result, the base member 12 is integrally attached to the front surface of the disc tray 5.

As shown in FIG. 6, in a state where the disc tray 5 is housed in the apparatus main body 3 and the insertion/ejection port 6 is closed by the lid body 11, the base member 12 integrally attached to the disc tray 5 pulls, in the direction (denoted by the arrow D shown in FIG. 6) that draws the lid body 11 in the insertion/ejection port 6, the elastic members 13, 13 whose one ends are fixed to the lid-side fixation pieces 14, 14 to extend the elastic members 13, 13, allowing the back surface of the lid body 11 to be spaced apart from the edge portion of the cover plate 21 of the base member 12 so as to draw the lid body 11 in the insertion/ejection port 6. Accordingly, the lid-side abutting portion 17 is brought into pressure contact with the panel-side abutting portions 34, 34 of the insertion/ejection port 6, and substantially the center portion of the lower side of the lid body 11 is brought into pressure contact with the abutting portion 35 to thereby allow the lid body 11 to be firmly attached to the insertion/ejection port 6, making it hard for dust or the like to be introduced through the space 8 between the insertion/ejection port 6 and lid body 11. Note that in a state where the insertion/ejection port 6 is closed by the lid body 11 (FIG. 6), the elastic member 13 may be in a normal state, where the elastic member 13 is not extended.

When the eject button 7b is depressed for, e.g., replacement of the optical disc 2, the disc tray 5 is ejected from the apparatus main body 3. At this time, as shown in FIG. 7, the edge portion of the cover plate 21 of the base member 12 integrally attached to the disc tray 5 is brought close to the back surface of the lib body 11 by a contraction force (in the direction of the arrow D shown in FIG. 7) of the elastic member 13. In this state, the disc tray 5 is moved outside the apparatus main body 3.

After completion of e.g., replacement of the optical disc 2, the eject button 7b is depressed once again, and the disc tray 5 is housed in the apparatus main body 3. Immediately before the lid body 11 is substantially fitted to the insertion/ejection port 6, the lid body 11 is attached to the base member 12 integrally attached to the front surface portion of the disc tray 5 by the elastic member 13. In this state, the upward movement of the lid body 11 is restricted due to the overlap of the cover plate 21 of the base member 12 on the position restricting piece 16, and the lid body 11 can move in the left, right, up and down directions relative to the base member 12 within a range of the restricting holes 27, 27 to which the restricting pins 18, 18 are inserted. Further, the lid-side inclined surface 20 inclined outwardly from the back surface side toward front surface side is formed on the outer peripheral surface of the lid body 11, and panel-side inclined surface 36 corresponding to the lid-side inclined surface 20 of the lid body 11 is formed on the side surface of the concave 6a of the insertion/ejection port 6. Therefore, even if the lid body 11 is displaced relative to the insertion/ejection port 6, the lid-side inclined surface 20 is brought into contact with the panel-side inclined surface 36, and the lid body 11 is drawn toward the insertion/ejection port 6 while the position of the lid body 11 relative to the base member 12 is corrected. Consequently, the lid body 11 is substantially fitted to the insertion/ejection port 6.

The size of the gap 8 formed between the lid body 11 and insertion/ejection port 6 is smaller than before, as described above. However, since the elastic member 13 allows the lib body 11 to be movable relative to the base member 12, even when a large installation error occurs among the lid body 11, disc tray 5, and base member 12, the lid body 11 is substantially fitted to the insertion/ejection port 6 without fail while the position of the lid body 11 relative to the base member 12 is corrected. Eventually, the lid body 11 is much more smoothly fitted to the insertion/ejection port 6 by the lid-side inclined surface 20 and panel-side inclined surface 36. According to the recording/reproducing apparatus 1 having the configuration described above, the gap 8 between the insertion/ejection port 6 and lid body 11 is so small that it is possible to prevent dust or the like from being introduced into the apparatus main body 3 and to improve the appearance of the apparatus.

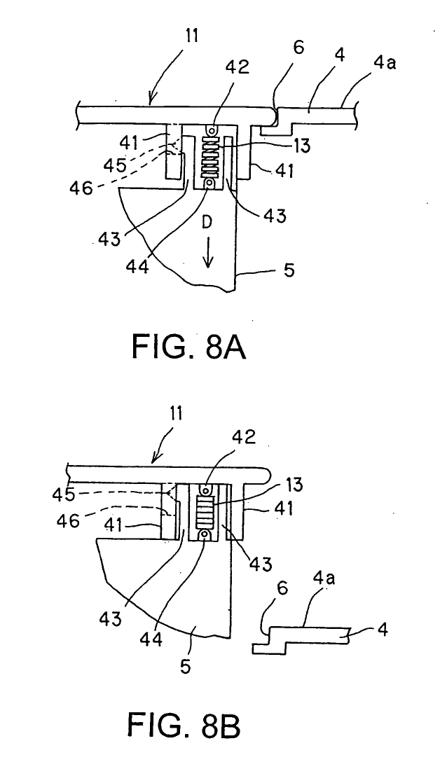

A modification of the present invention will next be described with reference to FIG. 8. FIG. 8 shows an example in which the lid body 11 is directly attached to the disc tray 5 without using the base member 12. As shown in FIGS. 8A and 8B, a pair of attachment pieces 41, 41 extending in parallel with each other are formed on both longitudinal sides of the lid body 11, and a lid-side fixation piece 42 for fixing one end of the elastic member 13 is formed between the attachment pieces 41, 41. A pair of guide pieces 43, 43 extending in parallel with each other and positioned between the attachment pieces 41,41 of the lid body 11 are formed on the front surface portion of the disc tray 5, and a tray-side fixation piece 44 for fixing the other end of the elastic member 13 is formed between the guide pieces 43, 43. Further, an engagement portion 45 is formed in one guide piece 43. The engagement portion 45 is engaged with an engagement hole 46 formed in one attachment piece 41. With the above configuration, the lid body 11 is coupled to the front surface portion of the disc tray 5 through the elastic member 13 and attached to the front surface portion of the disc tray 5 while being movable within a range of the engagement hole 46 to which the engagement portion 45 of the guide piece 43 is engaged.

As shown in FIG. 8A, in a state where the insertion/ejection port 6 is closed by the lid body 11, the disc tray 5 pulls, in the direction (denoted by the arrow D shown in FIG. 8A) that draws the lid body 11 in the insertion/ejection port 6, the elastic member 13 whose one end is fixed to the lid-side fixation piece 42 to extend the elastic member 13, allowing the back surface of the lid body 11 to be brought into pressure contact with the insertion/ejection port 6 to make it hard for dust or the like to be introduced through the space 8 between the insertion/ejection port 6 and lid body 11.

As shown in FIG. 8B, when the disc tray 5 is ejected from the apparatus main body 3, the back surface of the lib body 11 is brought close to the front surface portion of the disc tray 5 by a contraction force of the elastic member 13. In this state, the lid body 11 attached to the front surface of the disc tray 5 through the elastic member 13 can move within a range of the interval between the attachment portions 41, 41 and a range of the engagement hole 46 to which the engagement portion 45 is engaged. Therefore, even if the lid body 11 attached to the front surface of the disc tray 5 through the elastic member 13 is displaced relative to the insertion/ejection port 6 when the insertion/ejection port 6 is closed, the lid body 11 is substantially fitted to the insertion/ejection port 6 while the position of the lid body 11 relative to the base member 12 is corrected.

Therefore, according to the example shown in FIG. 8, it is possible to reduce the size of the gap 8 between the insertion/ejection port 6 and lid body 11, thereby preventing dust or the like from being introduced into the apparatus main body 3 and improving the outer appearance of the apparatus.

Although the optical disc 2 is placed on the disc tray 5 in the above examples, a recording medium to be placed on the disc tray 5 may include a magnet-optical disc and a magnetic disc, as well as a disc cartridge containing the above discs and a tape cartridge.

It should be understood by those skilled in the art that various modifications, combinations, sub-combinations and alternations may occur depending on design requirements and other factors insofar as they are within the scope of the appended claims or the equivalents thereof.

What is claimed is:

1. A recording and/or reproducing apparatus for recording/reproducing data onto/from a recording medium, comprising:
a chassis having an insertion/ejection port;
a recording medium tray for holding the recording medium, which transfers it into a recording and/or reproduction position where recording and/or reproduction of data onto/from the recording medium are performed or transfers it to an ejected position outside the chassis;
a panel in which the insertion/ejection port for the recording medium tray is formed and which is provided on one side surface of the main body of the apparatus;
a lid body which can close the insertion/ejection port; and
an elastic member provided between the lid body and recording medium tray.

2. The recording and/or reproducing apparatus according to claim 1, wherein, in a state where the insertion/ejection port is closed by the lid body, the elastic member elastically pulls the lid body toward the inside of the chassis.

3. The recording and/or reproducing apparatus according to claim 1, wherein a base member is fixed to the front surface portion of the recording medium tray, and the lid body is movably attached to the base member through the elastic member.

4. The recording and/or reproducing apparatus according to claim 2, wherein
a restricting pin for restricting displacement of the lid body movably attached to the base member through the elastic member is formed on the back surface of the lid body, and
a restricting hole into which the restricting pin is inserted is formed on a surface of the base member that faces the back surface of the lid body.

5. The recording and/or reproducing apparatus according to claim 1, wherein an inclined surface inclined outwardly is formed on the opening edge of the insertion/ejection port of the panel, and an inclined surface substantially parallel with the inclined surface of the insertion/ejection portion of the panel is formed on the outer peripheral surface of the lid body.
